(19) United States
(12) Patent Application Publication
(10) Pub. No.: US 2007/0156799 A1
(43) Pub. Date: Jul. 5, 2007

(54) Multi-stage finite impulse response filter processing

(76) Inventor: Michael J. Gilbert, Westford, MA (US)

Correspondence Address: VALEO RAYTHEON SYSTEMS, INC.;c/o DALY, CROWLEY, MOFFORD AND DURKEE, LLP, 354A TURNPIKE STREET, SUITE 301-A, CANTON, MA, 02021-2714, US

(21) Appl. No.: 11/323,459

(22) Filed: Dec. 30, 2005

(51) Int. Cl. G06F 17/10

(52) U.S. Cl. 708/300

(57) ABSTRACT

In one aspect, the invention is a method of emulating an n-stage finite impulse response (FIR) filter. The method includes connecting an output of a one-stage FIR filter to an input of the one-stage FIR filter to form a feedback path. The method also includes configuring the one-stage FIR filter to send a feedback signal along the feedback path. The feedback signal corresponds to an output data signal from at least one of a first stage of the n-stage FIR filter through an n−1 stage of the n-stage FIR filter.

### CROSS-REFERENCE WITH OTHER PATENT APPLICATIONS

This patent application includes aspects from the following patent applications, which are all incorporated herein by reference in their entirety: application Ser. No. ______, filed _ having Attorney Docket Number: VRS-019PUS, inventor Dennis Hunt and entitled “GENERATING EVENT SIGNALS IN A RADAR SYSTEM”; application Ser. No. ______, filed _ having Attorney Docket Number: VRS-022PUS, inventors Dennis Hunt and W. Gordon Woodington and entitled “MULTICHANNEL PROCESSING OF SIGNALS IN A RADAR SYSTEM”; application Ser. No. ______, filed _ having Attorney Docket Number: VRS-024PUS, inventors Dennis Hunt and W. Gordon Woodington and entitled “VEHICLE RADAR SYSTEM HAVING MULTIPLE OPERATING MODES”; application Ser. No. ______, filed _having Attorney Docket Number: VRS-025PUS, inventor W. Gordon Woodington and entitled “REDUCING UNDESIRABLE COUPLING OF SIGNAL(S) BETWEEN TWO OR MORE SIGNAL PATHS IN A RADAR SYSTEM”; application Ser. No. ______, filed _ having Attorney Docket Number: VRS-026PUS, inventor W. Gordon Woodington and entitled “REDUCING UNDESIRABLE COUPLING OF SIGNAL(S) BETWEEN TWO OR MORE SIGNAL PATHS IN A RADAR SYSTEM”; and application Ser. No. ______, filed _ having Attorney Docket Number: VRS-014PUS, inventors Stephen P. Lohmeier and Wilson J. Wimmer and entitled “SYSTEM AND METHOD FOR GENERATING A RADAR DETECTION THRESHOLD”.

### TECHNICAL FIELD

The invention relates to finite impulse response (FIR) filters.

### BACKGROUND

A finite impulse response (FIR) filter is a digital filter. The impulse response is considered “finite” since no feedback is required in the FIR filter. If an impulse signal is injected into the filter (i.e., a “1” or unity-valued sample preceded and followed by “0” or zero-valued samples), the impulse response of the FIR filter would be a set of filter coefficients.

Typically, the FIR filter is characterized by a decimation ratio and a number of taps. Decimation is the process of filtering and downsampling a signal to decrease its effective sampling rate. A FIR filter having a decimation ratio of two means that the sampling rate at the input of the FIR filter is one-half of the sampling rate at the output of the FIR filter. A tap is a coefficient-delay pair. Two or more FIR filters may be connected in series to form a multi-stage FIR filter.

### SUMMARY

In one aspect, the invention is a method of emulating an n-stage finite impulse response (FIR) filter. The method includes connecting an output of a one-stage FIR filter to an input of the one-stage FIR filter to form a feedback path. The method also includes configuring the one-stage FIR filter to send a feedback signal along the feedback path. The feedback signal corresponds to an output data signal from at least one of a first stage of the n-stage FIR filter through an n−1 stage of the n-stage FIR filter.

In another aspect, the invention is a finite impulse response (FIR) filter having an input and an output. The FIR filter includes a sample memory configured to receive sample data from the input of the FIR filter and feedback data, an adder coupled to receive data from the sample memory and a coefficient memory configured to store FIR filter coefficient values. Each of the FIR filter coefficient values corresponds to the filter coefficient values for a particular stage of an n-stage FIR filter. The FIR filter also includes a multiplier configured to receive the sample data from the adder and the FIR filter coefficient values from the coefficient memory and to combine the sample data and the FIR filter coefficient values to generate a product signal. The FIR filter further includes an accumulator configured to receive the product signal from the multiplier at an input thereof and to provide a FIR filter stage output signal at an output thereof, and a feedback signal path coupled between the output of the accumulator and the input of the sample memory and configured to provide the feedback data.

One or more of the aspects above may have one or more of the following advantages. A single stage FIR filter may be configured to have the performance characteristics of a multi-stage FIR filter finite impulse. Using the feedback signal approach and applying filter coefficients for different FIR filter stages at appropriate points in time reduces the amount of hardware required to have multi-stage FIR filter functionality. Furthermore, the technique essentially allows a single stage FIR filter to process different stages of the multi-stage FIR filter in parallel or in serial. The advantages listed are not intended to include each and every advantage. Other advantages will be apparent to one skilled in the art in light of the claims, drawings and description.

### DESCRIPTION OF THE DRAWINGS

FIG. 1 is a diagrammatic view of a pair of vehicles traveling along a roadway.

FIG. 2 is a block diagram of a vehicle system architecture.

FIG. 3 is a block diagram of a vehicle radar system.

FIG. 4 is a block diagram of a receiver.

FIG. 5 is a block diagram of an analog-to-digital converter (ADC).

FIG. 6 is a block diagram a finite impulse response (FIR) filter

FIG. 7 is a flowchart of an exemplary process used by the FIR filter.

FIG. 8 is a flowchart of another exemplary process used by the FIR filter.

FIG. 9 is a block diagram of a computer system on which the processes of FIGS. 7 and 8 may be implemented.

### DETAILED DESCRIPTION

Described herein is a novel approach for implementing a single stage finite impulse response (FIR) filter in such a way that it emulates a multi-stage FIR filter. While the novel FIR filter described herein is utilized in a receiver of an automatic radar system, it should be appreciated that the novel FIR filter may be utilized in other applications including but not limited to radar systems and communication systems.

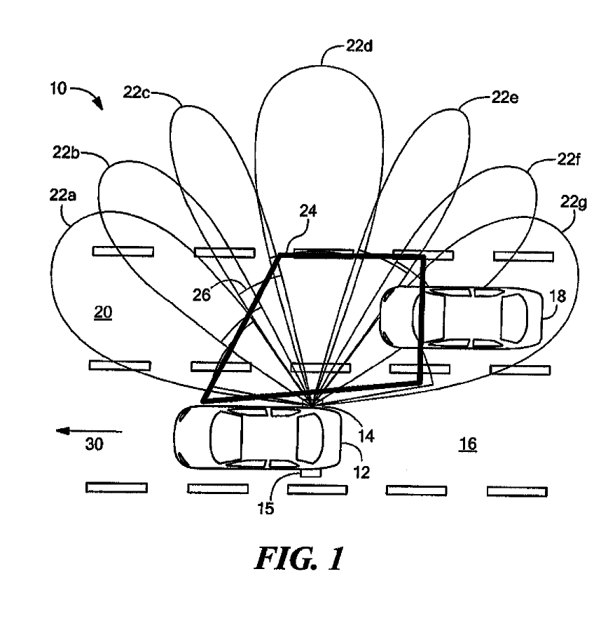

Referring to FIG. 1, a first vehicle 12 traveling in a first traffic lane 16 of a road includes a side-object detection (SOD) system 14. The SOD system 14 is disposed on a side portion of the vehicle 12 and in particular, the SOD system 14 is disposed on a right rear quarter of the vehicle 14. The vehicle 12 also includes a second SOD system 15 disposed on a side portion of a left rear quarter of the vehicle 12. The SOD systems 14, 15 may be coupled to the vehicle 12 in a variety of ways. In some embodiments, the SOD systems may be coupled to the vehicle 12 as described in U.S. Pat. No. 6,489,927, issued Dec. 3, 2002, which is incorporated herein by reference in its entirety. A second vehicle 18 travels in a second traffic lane 20 adjacent the first traffic lane 16. The first and second vehicles 12, 18 are both traveling in a direction 30 and in the respective first and second traffic lanes 16, 20.

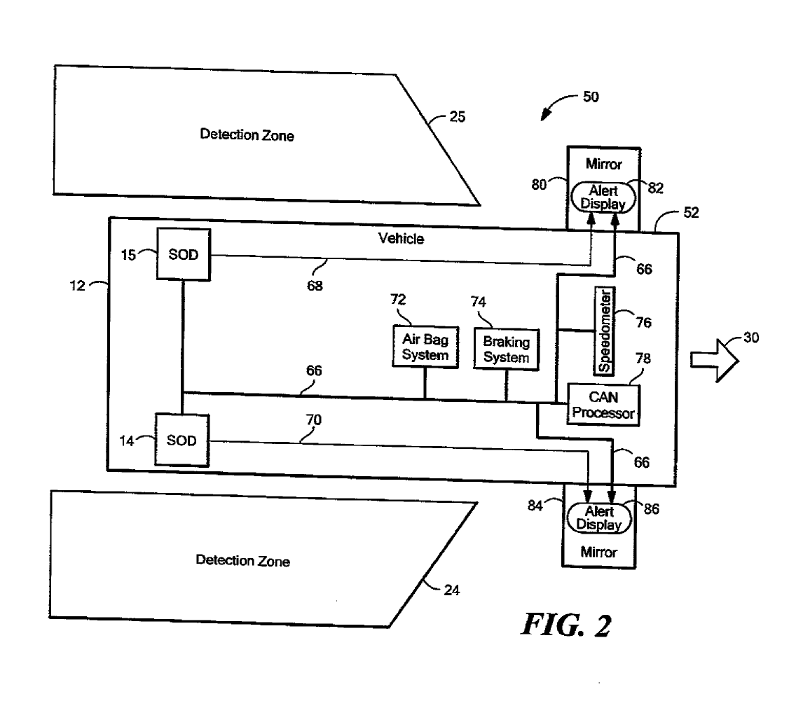

The second vehicle 18 may be traveling slower than, faster than, or at the same speed as the first vehicle 12. With the relative position of the vehicles 12, 18 shown in FIG. 1, the second vehicle 18 is positioned in a “blind spot” of the first vehicle 12. The blind spot is an area located on a side of the first vehicle 12 whereby an operator of the first vehicle 12 is unable to see the second vehicle 18 either through side-view mirrors 84, 86 (see FIG. 2) or a rear-view mirror (not shown) of the first vehicle 12.

The SOD system 14 generates multiple receive beams (e.g., a receive beam 22a, a receive beam 22b, a receive beam 22c, a receive beam 22d, a receive beam 22e, a receive beam 22f and a receive beam 22g) and an associated detection zone 24. The detection zone 24 is formed by the SOD system 14 by way of maximum detection ranges associated with each one of the receive beams 22a-22g, for example, the maximum detection range 26 associated with the receive beam 22c. Each of the receive beams 22a-22g may also have a minimum detection range (not shown), forming an edge 17 of the detection zone 24 closest to the first vehicle.

In one particular embodiment, the SOD system 14 is a frequency modulated continuous wave (FMCW) radar, which transmits continuous wave chirp radar signals, and which processes received radar signals accordingly. In some embodiments, the SOD system 14 may be of a type described, for example, in U.S. Pat. No. 6,577,269, issued Jun. 10, 2003; U.S. Pat. No. 6,683,557, issued Jan. 27, 2004; U.S. Pat. No. 6,642,908, issued Nov. 4, 2003; U.S. Pat. No. 6,501,415, issued Dec. 31, 2002; and U.S. Pat. No. 6,492,949, issued Dec. 10, 2002, which are all incorporated herein by reference in their entirety.

In operation, the SOD system 14 transmits an RF signal having portions which impinge upon and are reflected from the second vehicle 18. The reflected signals (also referred to as “echo” signals) are received in one or more of the receive beams 22a-22g. Other ones of the radar beams 22a-22g, which do not receive the echo signal from the second vehicle 18, receive and/or generate other radar signals, for example, noise signals. As used herein, the term “noise signal” is used to describe a signal comprised of one or more of a thermal noise signal, a quantization noise signal, a crosstalk signal (also referred to as leakage or feed through signal), and an ambient RF noise signal.

In some embodiments, the SOD system 14 may transmit RF energy in a single broad transmit beam (not shown). In other embodiments, the SOD system 14 may transmit RF energy in multiple transmit beams (not shown), for example, in seven transmit beams associated with the receive beams 22a-22g.

In operation, the SOD system 14 may process the received radar signals associated with each one of the receive beams 22a-22g in sequence, in parallel, or in any other time sequence. The SOD system 14 may be adapted to identify an echo radar signal associated with the second vehicle 18 when any portion of the second vehicle 18 is within the detection zone 24. Therefore, the SOD system 14 is adapted to detect the second vehicle 18 when at least a portion of the second vehicle is in or near the blind spot of the first vehicle 12.

Referring to FIG. 2, an exemplary vehicle system 50 which may be the same as or similar to the vehicle systems included in vehicles 12, 18 described above in conjunction with FIG. 1, includes vehicle systems such as SOD systems 14, 15, an air bag system 72, a braking system 74 and a speedometer 76.

Each one of the SOD systems 14, 15 is coupled to a CAN processor 78 through a Controller Area Network (CAN) bus 66. As used herein, the term “controller area network” is used to describe a control bus and associated control processor typically found in vehicles. For example, the CAN bus and associated CAN processor may control a variety of different vehicle functions such as anti-lock brake functions, air bags functions and certain display functions.

The vehicle 12 includes two side-view mirrors 80, 84, each having an alert display 82, 86, respectively, viewable therein. Each one of the alert displays 82, 86 is adapted to provide a visual alert to an operator of a vehicle in which system 50 is disposed (e.g., vehicle 12 in FIG. 1) to indicate the presence of another vehicle in a blind spot of the vehicle). To this end, in operation, the SOD system 14 forms detection zone 24 and SOD system 15 forms a detection zone 25.

Upon detection of an object (e.g., another vehicle) in the detection zone 24, the SOD system 14 sends an alert signal indicating the presence of an object to either or both of the alert displays 82, 84 through the CAN bus 66. In response to receiving the alert signal, the displays provide an indicator (e.g., a visual, audio, or mechanical indicator) which indicates the presence of an object. Similarly, upon detection of an object in the detection zone 25, SOD system 15 sends an alert signal indicating the presence of another vehicle to one or both of alert displays 82, 86 through the CAN bus 66. However, in an alternate embodiment, the SOD system 14 may communicate the alert signal to the alert display 82 through a human/machine interface (HMI) bus 68. Similarly, SOD system 15 may communicate the alert signal to the other alert display 86 through another human/machine interface (HMI) bus 70.

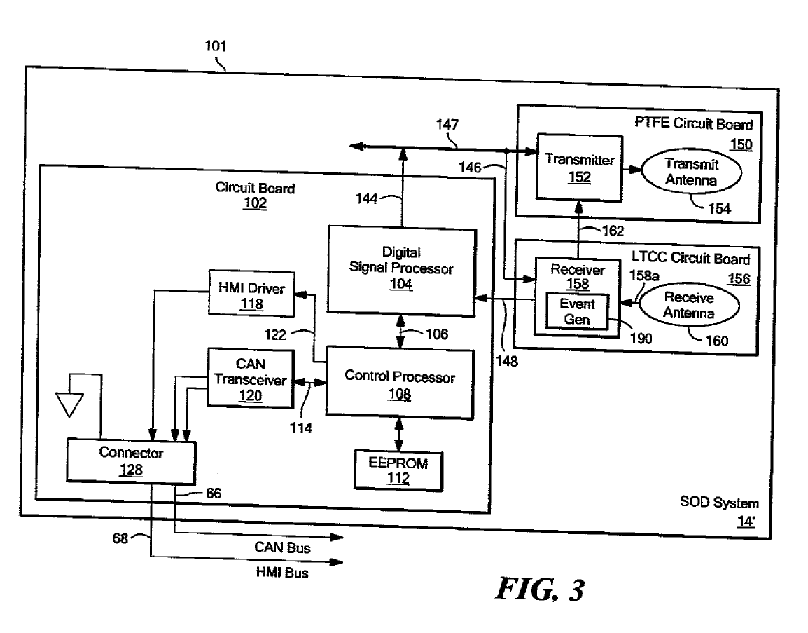

Referring to FIG. 3, a SOD system 14′ which may be the same as or similar to SOD 14 described above in conjunction with FIGS. 1 and 2, includes a housing 101, in which a fiberglass circuit board 102, a polytetrafluoroethylene (PTFE) circuit board 150, and a low temperature co-fired ceramic (LTCC) circuit board 156 reside.

The fiberglass circuit board 102 has disposed thereon a digital signal processor (DSP) 104 coupled to a control processor 108. In general, the DSP 104 is adapted to perform signal processing functions, for example, fast Fourier transforms on signals provided thereto from the receiver. The control processor 108 is adapted to perform digital functions, for example, to identify conditions under which an operator of a vehicle on which the SOD system 14 is mounted should be alerted to the presence of another object such as a vehicle in a blind spot.

The control processor 108 is coupled to an electrically erasable read-only memory (EEPROM) 112 adapted to retain a variety of values including but not limited to calibration values. Other read only memories associated with processor program memory are not shown for clarity. The control processor 108 is coupled to a CAN transceiver 120, which is adapted to communicate, via a connector 128, on the CAN bus 66.

The control processor 108 is coupled to an optional human/machine interface (HMI) driver 118, which may communicate via the connector 128 to the HMI bus 68. The HMI bus 68 may include any form of communication media and communication format, including, but not limited to, a fiber optic media with an Ethernet format, and a wire media with a two state format.

The PTFE circuit board 150 includes a radar transmitter 152, which is coupled to the DSP 104 through a serial port interface (SPI) 147 and a bus 144, and a transmit antenna 154, which is coupled to the radar transmitter 154.

The LTCC circuit board 156 includes a receiver 158, which is coupled to the DSP 104 through SPI 147 and a bus 146, and a receive antenna 160, which is coupled to the radar receiver 158. The radar transmitter 152 and the radar receiver 158 may receive the regulated voltages from the voltage regulator 134. The receiver 158 also provides RF signals to the transmitter 152 through a bus 162.

In operation, the DSP 104 generates one or more ramp signals (also referred to as chirp control signals) which are coupled through SPI 147 to the transmitter 152. Each ramp signal has a start voltage and an end voltage which is coupled to a signal source within the transmitter 152. In response to the ramp signals, the transmitter 152 (or more particularly, the signal source within the transmitter) generates RF signals having waveform and frequency characteristics controlled by the ramp signal. The transmitter feeds the RF signals to the transmit antenna 154 which emits (or radiates) the RF signals as chirp radar signals. As used herein, the term “chirp” is used to describe a signal having a characteristic (e.g., frequency) that varies with time during a time window. Typically, each chirp has an associated start and end frequency. A chirp may be a liner chirp, for which the frequency varies in a substantially linear fashion between the start and end frequencies.

The transmit antenna 154 may be provided having one or a plurality of transmit beams. Regardless of the number of transmit beams, the transmit antenna 154 transmits the chirp radar signal in a desired geographic area (e.g., over detection zone 24 in FIG. 1).

The receive antenna 160 may be provided having one or a plurality of receive beams. The SOD 14 in FIG. 1, for example, utilizes seven receive beams 22a-22g. Each of the receive beams receives received radar signals, or otherwise generates and/or receives noise radar signals. Signals associated with the receive beams are directed to the radar receiver 158. The radar receiver 158 receives the signals provided thereto from the antenna and provides an output signal on signal path 148. The receiver 158 appropriately processes the input signal provided thereto such that the output signal on signal path 148 can be appropriately received by the DSP 104.

The signal provided to the input of DSP 104 has a frequency content, wherein different frequencies of peaks therein correspond to detected objects at different ranges. The DSP 104 analyzes the signals provided thereto and identifies objects in the detection zone 24.

Some objects identified by the DSP 104 may be objects for which an operator of the first vehicle 12 (FIG. 1) has little concern and need not be alerted. For example, an operator of vehicle 12 may not, in some instances, may not need to be alerted as to the existence of a stationary guard rail along the road side. Thus, additional criteria may be used to determine when an alert signal should be generated and sent to the operator.

To utilize further criteria, the control processor 108 receives object detections on a bus 106 from the DSP 104. The control processor 108 applies a series of factors and characteristics (i.e., criteria used in addition to that used by DSP 104 to identify an object) to control generation of an alert signal. For example, upon determination by the control processor 108, the alert signal may be generated and sent through a bus 114 to CAN transceiver 120 and communicated on the CAN bus 66, which is indicative not only of an object in the detection zone 24, but also is indicative of an object having predetermined characteristics being in the detection zone. In other embodiments, an alert signal may be communicated by control processor 108 on a bus 122 through the HMI driver 118 to the HMI bus 68.

The fiberglass circuit board 102, the PTFE circuit board 150, and the LTCC circuit board 156 are comprised of materials having known behaviors for signals within particular frequency ranges. It is known, for example, that fiberglass circuit boards have acceptable signal carrying performance at signal frequencies up to a few hundred MHz. LTCC circuit boards and PTFE circuit boards are know to have acceptable signal carrying performance at much higher frequencies. Thus, the lower frequency functions of the SOD system 14 are disposed on the fiberglass circuit board 102, while the functions having frequencies in the radar range of frequencies (e.g., 2 GHz) are disposed on the LTCC and on the PTFE circuit boards 150, 156, respectively.

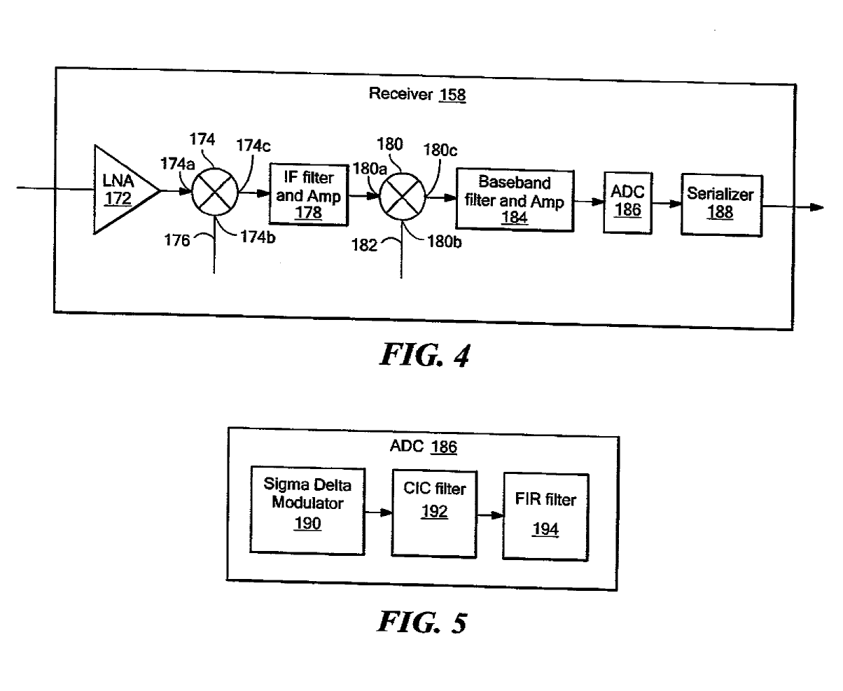

Referring to FIG. 4, the receiver 158 includes an RF low-noise amplifier (LNA) 172, a mixer 174, an intermediate frequency (IF) filter and amplifier 178, a mixer 180, a baseband filter and amplifier 184, an analog-to-digital converter (ADC) 186 and a serializer 188. An RF signal received through antenna 160 (FIG. 3) is provided to an input of the RF LNA 172. The RF LNA 172 provides an amplified version of the signal fed thereto to a first input port 174a of a mixer 174. An RF signal fed along signal path 176 to a second port 174b of the mixer 174 serves as a first local oscillator (LO) signal. Illustrative frequencies for the RF signals from the amplifier 172 and the first LO signal are on the order of 24 GHz and 17 GHz respectively. Mixer 176 receives the RF and the first LO signals provided thereto and provides a down-converted or intermediate frequency (IF) signal at a third port 174c thereof.

The down-converted signal is fed from the third port 174c of the mixer 174 to an IF filter and amplifier circuit 178. The IF filter and amplifier circuit 178 provides a suitably filtered and amplified version of the down-converted signal fed thereto to a first input port 180a of a second mixer 180. An RF signal is fed along a signal path 182 to a second port 180b of the mixer 180 and serves as a second LO signal. Illustrative frequencies for the RF signals from the filter and amplifier circuit 178 and the LO signal are on the order of 6 GHz. Although the exemplary receiver 158 is shown as a direct conversion, dual heterodyne receiver, other receiver topologies may also be used in the SOD system 14. Mixer 180 receives the RF and LO signals provided thereto and provides a second down converted or IF signal at a third port 180c thereof to an input port of a baseband filter and amplifier circuit 184. The baseband filter and amplifier circuit 184 provides a suitably filtered and amplified signal to an input of an analog-to-digital converter (ADC) 186.

The ADC 186 receives the analog signal fed thereto from filter and amplifier circuit 184 and converts the analog signal into digital signal samples which are serialized by a serializer 188 for further processing. In particular, the digital signal samples are coupled from the serializer 188 to a DSP (e.g., DSP 104 in FIG. 3) which processes the signals fed thereto to determine the content of the return signal within various frequency ranges.

Referring now to FIG. 5, the ADC 186 includes a sigma delta modulator 190 having an input port which corresponds to an input port of the ADC. An output port of the ADC 186 is coupled to an input of a cascaded integrated comb (CIC) filter 192. The output of the CIC filter 192 is coupled to an input of a FIR filter 194 and an output of the FIR filter corresponds to the output port of the ADC 186.

A sigma delta modulator 190 receives analog signals fed to the input port thereof and converts the analog signal fed thereto (e.g., from the baseband filter and amplifier circuit 184 in FIG. 4) into a sequence of digital bits or samples. The digital bit sequence is coupled from an output port of the ADC to the CIC filter 192. The CIC filter performs a coarse filtering operation on the digital bit sequence and subsequently provides the filtered digital bit sequence to the FIR filter 194. CIC filter 192 prevents a sharp transition band by providing a “coarse” approximation to the desired frequency. The FIR filter 194 performs a fine filtering operation on the digital samples by accurately matching the desired frequency response and provides the filtered digital bit sequence to the output port of the ADC 186.

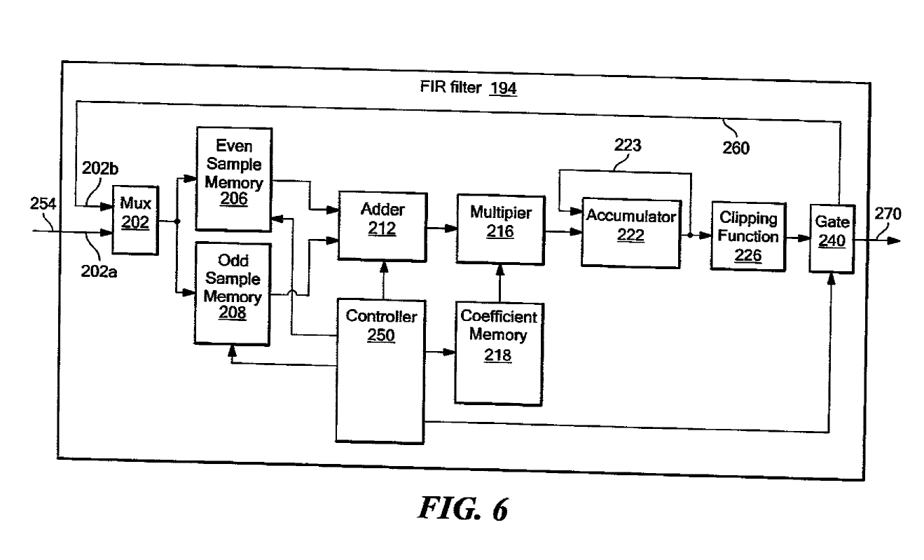

Referring now to FIG. 6, the FIR filter 194 of FIG. 5 is shown as a single stage FIR filter which has been modified in a manner to be explained below which allows the filter 194 to emulate a multistage FIR filter. Thus, the FIR filter 196 provides the functional benefits provided by a multi-stage FIR filter while utilizing substantially the same amount of circuit board space as a single stage FIR filter.

The FIR filter 194 includes a multiplexer (MUX) 202 having first and second input ports 202a, 202b. MUX input port 202a corresponds to an input port of the FIR filter 194 and MUX input port 202b is coupled to a feedback signal path 260. The feedback signal path 260 couples signals from an output signal path of the FIR filter to the input 202b of the MUX 202. The FIR filter 194 further includes an even sample memory 206, an odd sample memory 208, an adder 212, a multiplier 216, a coefficient memory 217, an accumulator 222, a clipping function 226, a gate 240 and a controller 250.

In operation, MUX 202 receives digital input data at input port 202a. In the exemplary embodiment of FIG. 5, the digital input data is provided from an output of the CIC filter 192. The second MUX input port 202b receives feedback data from the signal path 260. The feedback data corresponds to data which has been previously fed to the FIR input and processed by the remaining FIR filter components (i.e., memories 206, 208, 218 accumulators 212, 222, multiplier 216, clipping function 226 and gate 240).

The input data and the feedback data are both coupled from the MUX 202 and are both stored in the even sample memory 206 and the odd sample memory 208. For example, if the input samples are numbered 0, 1, 2, 3 and so forth then the even numbered samples are stored in the even sample memory, and the odd samples are stored in the odd sample memory. The adder 212 then reads the appropriate sample data (input data or feedback data) from the even and odd sample memories 206, 208 and provides the sample data to the multiplier 216. The adder 212 adds one sample from each of the even and odd sample memories. This sum becomes the input to the multiplier 216. The multiplier 216 performs a multiplication operation on the data provided thereto.

Thus, if simulating the second stage of a FIR filter, the first stage FIR filter output signal values have already been coupled from the output of clipping function 226 (via gate circuit 240) to the MUX input port 202b (via feedback signal path 260) and stored in the even and odd sample memories 206, 208. Accordingly, the values from the first stage filter operation can then be coupled from the memories 206, 208 to the multiplier 216 through the adder 212.

Since in this particular portion of the example the FIR filter 194 is emulating the second stage of a multi-stage FIR filter, the coefficient memory 218 provides (or otherwise makes available) the second stage FIR filter coefficients to the multiplier 216. The multiplier 216 appropriately combines the data values fed thereto from the adder 212 with the second stage FIR filter coefficient values received from the coefficient memory 218. The multiplier 216 then provides output values of this operation to the accumulator 222. For each output sample, the accumulator starts at zero and then adds successive values output from the multiplier until the output sample is complete.

The accumulator 222 provides the multiplier output values to the clipping function 226 and also couples the output values back to an input port thereof along an accumulator feedback path 223. The clipping function 226 replaces any overflow values received from the accumulator 222 with a maximum value based on the maximum value that can be represented by any particular implementation. Overflow values are not expected however, the clipping function 226 provides a stable output if the unexpected overflow occurs.

The controller 250 is coupled to the even odd sample memories 206, 208, the adder 212, the coefficient memory 218 and the gate 240 and controls the processing within FIR filter 194 to ensure that the appropriate data from the even and odd sample memories 206, 208 and corresponding data from the coefficient memory 218 are read at the proper point during the processing. The controller 250 also ensures that the gate 240 directs output data from the appropriate FIR filter stages to the multiplexer 202 through the signal path 260.

It should be appreciated that only data from the first stage of the FIR filter through the second-to-last stage of the FIR filter is directed through the feedback signal path 260 to the multiplexer 202. The output from the last stage of the FIR filter is directed toward the FIR filter output port which is shown as a signal path 270 in FIG. 6.

For example, if the FIR filter 194 is emulating a five stage filter, then the second-to-last filter stage would correspond to the fourth FIR filter stage. Thus, in this case, gate 240 directs data from the first four FIR filter stages back to the MUX 202 via feedback path 260 and gate 240 directs data from the fifth FIR filter stage to the FIR filter output port at the path 270.

Thus, when multiplier 216 receives from the coefficient memory 218 coefficient values corresponding to any one of the first four FIR filter stages, then gate 240 directs the resultant values fed thereto back to the MUX 202 through feedback signal path 260. However, when the multiplier 216 receives from the coefficient memory 218 coefficient values corresponding to the fifth FIR filter stage (i.e., the last FIR filter stage in this example), then gate 240 directs the values fed thereto toward the FIR filter output port at path 270.

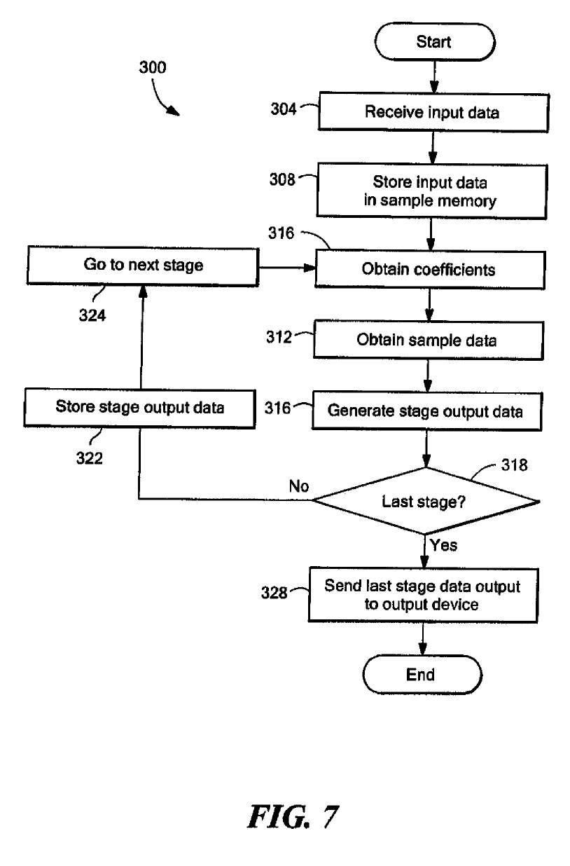

Turning now to FIG. 7, an exemplary process 300 for using a single stage FIR filter (such as filter 194 described above in conjunction with FIGS. 5 and 6) as a multistage FIR filter begins as shown in processing block 304 in which the filter receives input data from a digital device (e.g., CIC filter 192 in FIG. 5). Processing then continues to processing block 308 in which the input data is stored in a memory. In the exemplary embodiment of FIG. 6, for example, the input data is stored in the even and odd sample memories 206, 208.

In processing block 310, filter coefficients are obtained (or otherwise provided or read) from a storage device (e.g., coefficient memory 218 in FIG. 6). The values of each of the coefficients depends upon the filter stage being simulated in the single stage filter. For example, if the filter is simulating a four stage FIR filter, then coefficient values for each of the four stages must stored in a storage device such as the coefficient memory and the appropriate coefficients are used at the appropriate time during the simulation.

In processing block 312, data samples are obtained (or read or otherwise provided or retrieved) and are combined with the filter coefficient values to generate a FIR filter stage output as shown in processing block 316. In the embodiment of FIG. 6, for example, the data samples and filter coefficient values are first stored in a storage device and are then combined in a multiplier circuit (e.g., multiplier 216).

The generated output data values are then fed to decision block 318 in which a determination is made as to whether the last filter stage has been processed. For example, if the FIR filter 194 is simulating a FIR filter having five filter stages, the question is whether the filter output data has been provided by applying the filter coefficients for the fifth filter stage (i.e., the last filter stage) to the signal data.

If the last filter stage is the stage from which the output data is provided, then processing flows to decision block 328 in which the last stage data output is sent to an output device and processing then ends.

If, on the other hand, the last filter stage is not the stage from which the output data is provided, then decision block 318 implements a loop in which the output data from the stage presently being processed is stored (e.g., in the even and odd sample memories 206, 208 described above in FIG. 6) as shown in processing block 322 and then processing flows to processing blocks 324 and 310 in which the processing for the next FIR filter stage begins.

In the embodiment of FIG. 6, for example, the controller 250 instructs the adder 212 and the coefficient memory 218 to process sample data and coefficients associated with the next FIR filter stage processing. Processing blocks 310-328 are repeated until it is determined in decision block 318 that the last stage has been processed.

It should be appreciated that process 300 described above in conjunction with FIG. 7 processes data from each filter stage in series. That is, the data for the first filter stage is processed, then the data for the second filter stage is processed, and so forth. This results in the need for relatively large memory spaces in which input data values and intermediate processed FIR filter data values (i.e., the feedback data values) can be stored. In the embodiment of FIG. 6, for example, the even and odd sample memories 206, 208 hold the input data values and the feedback data values and thus these memories should be provided as relatively large memory devices.

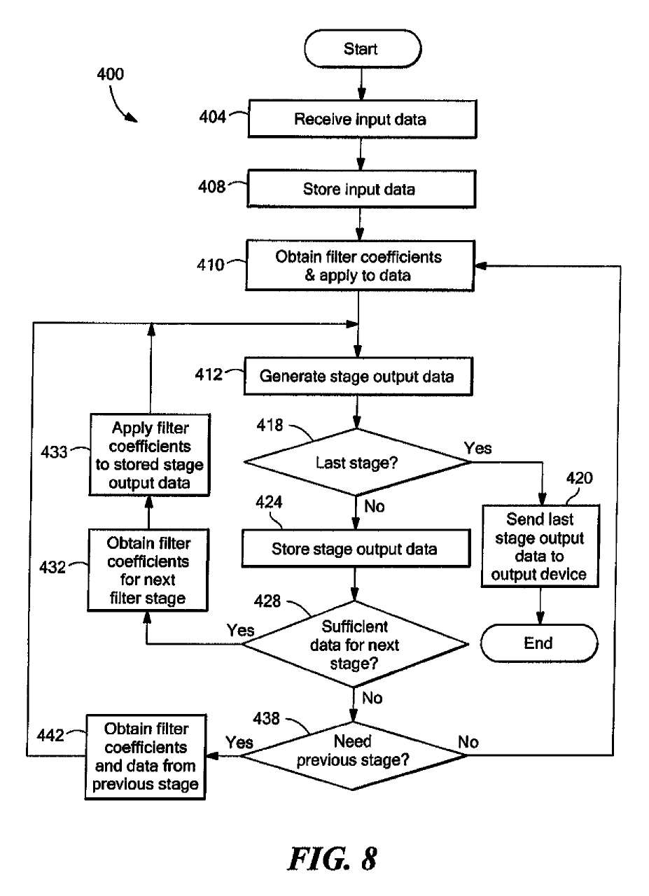

Referring now to FIG. 8, another exemplary process 400 for using a single stage FIR filter as a multistage filter begins as shown in processing block 404 in which the filter receives digital input data (i.e., sample data) from an input device (e.g., the CIC filter 192 of FIG. 6). The digital input data may be stored in a memory or other storage device (e.g., in the odd and even sample memories, 206, 208 of FIG. 6) as shown in processing block 408. In general, digital input data may be used multiple times, because each input sample contributes to multiple output samples. Furthermore, the input samples may not be used in the same order or at the same rate as they arrive, so that some storage is needed.

Processing then proceeds to processing block 410 in which an appropriate set of FIR filter coefficients are obtained and applied to the input data. The FIR filter coefficients may be obtained, for example, from a storage or other device such as coefficient memory 218 in FIG. 6. In the embodiment shown in FIG. 6, for example, the input data for the FIR filter stage being processed is obtained from the even and odd sample memories 206, 208 and the FIR filter coefficients for the FIR filter stage being processed are obtained from the coefficient memory 218. The filter coefficients are applied to the input data via the multiplier circuit 216 (FIG. 6). It should be appreciated that other techniques for applying the filter coefficients to the input data may, of course, also be used.

After the filter coefficients have been applied to the input data, then the output data for that filter stage is generated as shown in processing block 412. The output data for the stage is generated by appropriately adjusting the data. In the embodiment of FIG. 6, for example, the output data for the stage currently being emulated is generated by processing the output signal from the multiplier circuit 216 (i.e., the product of the filter coefficients and the sample) through the accumulator 222 and the clipping function 226.

In decision block 418, a decision is made as to whether the data which was generated is for the last (or final) FIR filter stage. If a decision is made that the last stage is being processed, then process 400 continuously produces the output data for the last stage and sends the output data from the last stage to an output device as shown in processing block 420. In the exemplary embodiment of FIGS. 4 to 6, for example, the FIR filter data from the last FIR filter stage is provided to serializer 188 (FIG. 4).

However, if in decision block 418, a decision is made that the last stage is not being processed, processing then proceeds to processing block 424 in which the output data from that stage is stored in a storage device for use in later processing. In the exemplary FIR filter embodiment of FIG. 6, for example, the FIR filter data is stored in the even and odd sample memories, 206, 208 (424).

It should be appreciated that the processing of the data for a given FIR filter stage can begin prior to full completion of the prior FIR filter stage. For example, in a three stage FIR filter, the processing of the data for the second stage can begin prior to full completion of the first stage data. However, at least some minimum amount of data for the prior FIR filter stage must be completed before the processing for the next FIR filter stage can begin.

Thus, as shown in processing block 424 process 400 stores output data for each stage until, as shown in decision block 428, it is determined that there is sufficient data available to begin the processing for the next FIR filter stage (i.e., an amount of output data for the current stage exists which is sufficient to allow processing at the next stage to begin).

If a decision is made in decision block 428 that sufficient output data for the next stage exists, then processing proceeds to processing block 432 in which the processing for the next filter stage begins by obtaining the FIR filter coefficients for the next FIR filter stage. Processing then proceeds to processing block 433 in which the FIR filter coefficients obtained in processing block 432 are applied to the stage output data which was stored during process 424. In the exemplary embodiment of FIG. 6, for example, the controller 250 instructs the adder 212 and the coefficient memory 218 to begin processing corresponding to the next FIR filter stage. Processing then flows to processing block 412 in which the output data for that stage is generated.

It should be appreciated that each set of FIR filter coefficients corresponds to a stage of the FIR filter. Thus, if a four stage FIR filter is being emulated by the single stage FIR filter architecture of the present invention, then four sets of filter coefficients are used (i.e., one set of filter coefficients for each FIR filter stage). It should also be appreciated, of course, that in some instances the same filter coefficients may be used for multiple FIR filter stages. For example, FIR filter stages two and three may use the same coefficients. In this case, it is only necessary to store three sets of FIR filter coefficients (rather than four sets) since one set of filter coefficients can be used for more than one filter stage.

By processing the next filter stage, before the present stage processing is fully complete, less memory capacity is required in the odd and even sample memories, 206, 208.

If in decision block 428 decision is made that there is not sufficient output data from the stage to allow processing of the next stage to begin, then processing flows to decision block 438 in which a decision is made as to whether output data from a previous stage is needed.

If output data from the previous stage is needed, processing flows to processing block 442 where filter coefficients and data from the previous stage are obtained. Processing then flows to processing block 412. In the exemplary embodiment of FIG. 6, for example, the controller 250 instructs the adder 212 and the coefficient memory 218 to begin processing using values from the previous stage.

If in decision block 438 a decision is made that data from the previous stage is not needed, then processing flows directly to processing block 410 where data from the current stage continues to be processed.

In one example of using process 400, a three-stage FIR filter includes a first stage having fourteen taps, a second stage having twenty-four taps and a third stage having eighty taps and each stage has a decimation ratio of two. Each stage is symmetrical so that two taps are processes for each multiplication and the multiplier 216 runs at 256 MHz and the output rate is 2 MHz. The schedule for the multiplier 216 would include first using seven time slots to begin processing first stage and then using an additional seven time slots to complete processing for the first stage. Having processed a total of fourteen time slots for the first stage, the multiplier 216 then processes the next twelve time slots for the second stage.

The multiplier 216 returns to processing the next seven time slots for the first stage and the following seven time slots for the first stage. The multiplier 216 processes the next twelve time slots for the second stage. The multiplier 216 returns to processing the next forty time slots for the third stage.

Of the 128 total time slots available, thirty-six are unused. If usage of the even and odd sample memories, 206, 208 was perfectly efficient, then the number of samples stored for each stage would be equal to the number of taps. Since the processing for each stage can be “bursty”, extra samples are stored to ensure that no previously stored samples are overwritten before they are still needed for processing. Therefore, the worst-case number of extra samples that would be stored for each stage is equal to the total decimation from that stage forward. In the example above, eight extra samples are needed for the first stage, four extra samples are needed for the second stage and two extra samples are needed for the third stage.

With this approach, process 400 for emulating a multistage filter with a single stage FIR filter requires less memory capacity than process 300 described above in conjunction with FIG. 6. Thus, in the exemplary circuit of FIG. 6, the even and odd sample memories 206, 208 can be provided having smaller memory capacity than if the process 300 of FIG. 7 were used.

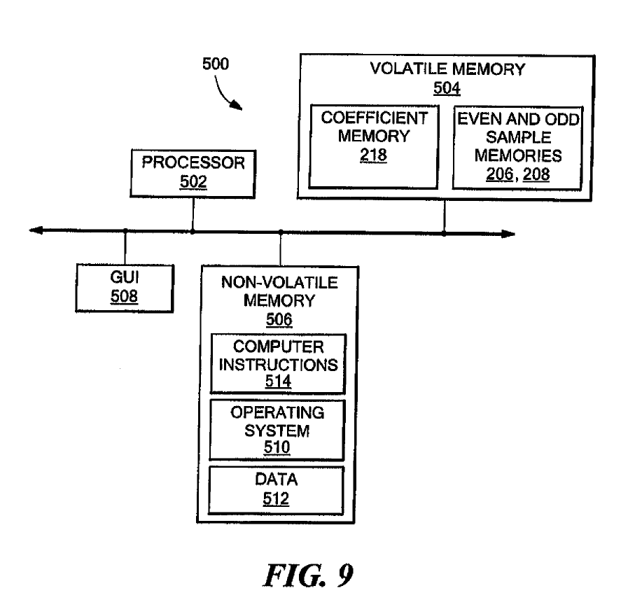

FIG. 9 shows a computer 500 adapted to use either or both of processes 300 and 400. Computer 500 includes a processor 502, a volatile memory 504, a non-volatile memory 506 (e.g., hard disk) and a graphical user interface 508. Non-volatile memory 506 stores operating system 510; data 512 including FIR filter data such as a number of stages, the number of taps and the decimation ratio, and computer instructions 514, which are executed by processor 502 out of the volatile memory 504 to perform processes 300 and 400. The non-volatile memory 504 includes odd and even sample memory coefficients 206, 208 and coefficient memory 218. The GUI 508 is used by a user to configure (1) the decimation ratio for each FIR filter stage, (2) the number of the taps for each FIR filter stage, and (3) the number of FIR filter stages and stored in the data 512.

Processes 300 and 400 are not limited to use with the hardware and software of FIG. 9; it may find applicability in any computing or processing environment and with any type of machine that is capable of running a computer program. Processes 300 and 400 may be implemented in hardware, software, or a combination of the two. Processes 300 and 400 may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processes 300 and 400 and to generate output information.

The system may be implemented, at least in part, via a computer program product (i.e., a computer program tangibly embodied in an information carrier (e.g., in a machine-readable storage device or in a propagated signal, for execution by, or to control the operation of, data processing apparatus (e.g., a programmable processor, a computer, or multiple computers)). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer to perform processes 300 and 400. Processes 300 and 400 may also be implemented as a machine-readable storage medium, configured with a computer program, where upon execution, instructions in the computer program cause the computer to operate in accordance with processes 300 and 400.

The processes described herein are not limited to the specific embodiments described herein. For example, the processes are not limited to the specific processing order of FIGS. 7 and 8. Rather, any of the blocks of FIG. 7 and FIG. 8 may be re-ordered, repeated, combined or removed, performed in parallel or in series, as necessary, to achieve the results set forth above. In another example, the gate 240 may be used prior to the clipping function 240. In other examples, the gate 240 may be implemented as a clock enable for the following stage. Furthermore, the gate 240 may be configured to prevent undefined data from being passed to other components.

While two SOD systems 14, 15 are shown in FIGS. 1 and 2, the system 50 may include any number of SOD systems, including a single SOD system. While the alert displays 82, 86 are shown to be associated with side-view mirrors, the alert displays may be provided in a variety of ways. For example, in other embodiments, the alert displays may be associated with a rear view mirror (not shown). In other embodiments, the alert displays are audible alert displays.

While the CAN bus 66 is shown and described, it will be appreciated that the SOD systems 14, 15 may couple through any of a variety of other busses within the vehicle 12, including, but not limited to, an Ethernet bus, and a custom bus.

The system described herein is not limited to use with the hardware and software described above. The system may be implemented in digital electronic circuitry, or in computer hardware, firmware, software, or in combinations thereof.

While three circuit boards 102, 150, 156 are described herein, the SOD system 14 may be provided on more than three or fewer than three circuit boards. Also, the three circuit boards 102, 150, 156 may be comprised of other materials than those shown in FIG. 2.

Method steps associated with implementing the system may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer include a processor for executing instructions and one or more memory devices for storing instructions and data.

The system is not limited to the specific examples described herein. For example, while the system described herein is within a vehicle radar system, the system may be used in any vehicle system requiring the evaluation of power supply interference. While fast Fourier transforms (FFTs) are described below, which perform a conversion of time domain signals to the frequency domain, a variety of other transforms may be used, for example, discrete Fourier transforms (DFTs).

Elements of different embodiments described herein may be combined to form other embodiments not specifically set forth above. Other embodiments not specifically described herein are also within the scope of the following claims.

What is claimed is:

1. A method of emulating an n-stage finite impulse response (FIR) filter, the method comprising:
connecting an output of a one-stage finite impulse response (FIR) filter to an input of the one-stage FIR filter to form a feedback path; and
configuring the one-stage FIR filter to send a feedback signal along the feedback path, the feedback signal corresponding to an output data signal from at least one of a first stage of the n-stage FIR filter through an n−1 stage of the n-stage FIR filter.

2. The method of claim 1, further comprising combining the feedback signal with an input signal to provide an input to the one-stage FIR filter.

3. The method of claim 2, further comprising configuring the one-stage FIR filter to emulate n stages of the n-stage FIR filter using the feedback data and the input data.

4. The method of claim 1, further comprising configuring the one-stage FIR filter to:
generate first stage output data corresponding to an output of a first stage of the n-stage FIR filter; and
if a sufficient number of the first stage output data is received, generate at least a portion of second stage output data corresponding to a second stage of the n-stage FIR filter before generating further first stage output data.

5. The method of claim 4, further comprising configuring the one-stage FIR filter to:
generate the further first stage output data; and
if a sufficient number of the further first stage output data is generated, generate further second stage output data.

6. The method of claim 5, further comprising configuring the one-stage FIR filter to:
if a sufficient number of an (n−1)th stage output data corresponding to a (n−1)th stage of the n-stage FIR filter is generated, generate nth stage output data corresponding to an nth stage of the n-stage FIR filter; and
send the nth stage output data to an output device.

7. The method of claim 1, further comprising configuring the one-stage FIR filter to generate second stage output data corresponding to a second stage of the n-stage FIR filter after generating first stage output data corresponding to a first stage of the n-stage FIR filter.

8. The method of claim 1, further comprising configuring the one-stage FIR filter to emulate the n stages of the n-stage FIR filter based on decimation ratios selected by a user.

9. The method of claim 1, further comprising configuring the one-stage FIR filter to emulate the n stages of the n-stage FIR filter based on tap parameters selected by a user.

10. The method of claim 1, further comprising configuring the one-stage FIR filter to emulate the n stages of the n-stage FIR filter based on a number of stages selected by a user.

11. The method of claim 1, further comprising further comprising configuring the one-stage FIR filter to send output data corresponding to the nth stage of the n-stage FIR filter to an output device.

12. An article comprising a machine-readable medium that stores executable instructions for emulating an n-stage finite impulse response (FIR) filter, the instructions causing a machine to:
connect an output of a one-stage finite impulse response (FIR) filter to an input of the one-stage FIR filter to form a feedback path; and
configure the one-stage FIR filter to send a feedback signal along the feedback path, the feedback signal corresponding to an output data signal from at least one of a first stage of the n-stage FIR filter through an n−1 stage of the n-stage FIR filter.

13. The article of claim 12, further comprising instructions causing a machine to:
generate first stage output data corresponding to an output of a first stage of the n-stage FIR filter; and
if a sufficient number of the first stage output data is received, generate at least a portion of second stage output data corresponding to a second stage of the n-stage FIR filter before generating further first stage output data.

14. The article of claim 13, further comprising instructions causing a machine to:
if a sufficient number of an (n−1)th stage output data corresponding to a (n−1)th stage of the n-stage FIR filter is generated, generate nth stage output data corresponding to an nth stage of the n-stage FIR filter; and
send the nth stage output data to an output device.

15. The article of claim 12, further comprising instructions causing a machine to configure the one-stage FIR filter to generate second stage output data corresponding to a second stage of the n-stage FIR filter after generating first stage output data corresponding to a first stage of the n-stage FIR filter.

16. An apparatus comprising:
a memory that stores executable instructions for emulating an n-stage finite impulse response (FIR) filter; and
a processor that executes the instructions to:
connect an output of a one-stage finite impulse response (FIR) filter to an input of the one-stage FIR filter to form a feedback path; and
configure the one-stage FIR filter to send a feedback signal along the feedback path, the feedback signal corresponding to an output data signal from at least one of a first stage of the n-stage FIR filter through an n−1 stage of the n-stage FIR filter.

17. The apparatus of claim 16, further comprising instructions to:
generate first stage output data corresponding to an output of a first stage of the n-stage FIR filter; and
if a sufficient number of the first stage output data is received, generate at least a portion of second stage output data corresponding to a second stage of the n-stage FIR filter before generating further first stage output data.

18. The apparatus of claim 17, further comprising to:
if a sufficient number of an (n−1)th stage output data corresponding to a (n−1)th stage of the n-stage FIR filter is generated, generate nth stage output data corresponding to an nth stage of the n-stage FIR filter; and
send the nth stage output data to an output device.

19. The apparatus of claim 16, further comprising instructions to configure the one-stage FIR filter to generate second stage output data corresponding to a second stage of the n-stage FIR filter after generating first stage output data corresponding to a first stage of the n-stage FIR filter.

20. A finite impulse response (FIR) filter having an input and an output, the FIR filter comprising:
a sample memory configured to receive sample data from the input of the FIR filter and feedback data;
an adder coupled to receive data from the sample memory;
a coefficient memory, configured to store FIR filter coefficient values, each of the FIR filter coefficient values corresponding to filter coefficient values for a particular stage of an n-stage FIR filter;
a multiplier configured to receive the sample data from the adder and the FIR filter coefficient values from the coefficient memory and to combine the sample data and the FIR filter coefficient values to generate a product signal;
an accumulator adapted to receive the product signal from the multiplier at an input thereof and to provide a FIR filter stage output signal corresponding to at least one of n stages of the n-stage FIR filter at an output thereof; and
a feedback signal path coupled between the output of the accumulator and the input of the sample memory and configured to provide the feedback data.

21. The FIR filter of claim 20 wherein the sample memory comprises an odd sample memory portion and even sample memory portion.

22. The FIR filter of claim 20 wherein the FIR filter is configured to send a feedback data along the feedback path, the feedback data corresponding to the FIR filter stage output signal from at least one of a first stage of an n-stage FIR filter through an n−1 stage of the n-stage FIR filter.

23. The FIR filter of claim 20 further comprising a controller coupled to the adder to control the data values provided to the multiplier from the adder, to the coefficient memory to control the coefficient memory values provided to the multiplier from the coefficient memory, and to the sample memory to control the sample data provided to the adder.

24. A receiver in a side object detection system disposed in a vehicle, the receiver comprising:
an analog-to-digital converter comprising a finite impulse response (FIR) filter, the FIR comprising:
a sample memory configured to receive sample data from an input of the FIR filter and feedback data;
an adder coupled to receive data from the sample memory;
a coefficient memory configured to store FIR filter coefficient values, each of the FIR filter coefficient values corresponding to filter coefficient values for a particular stage of an n-stage FIR filter;
a multiplier configured to receive the sample data from the adder and the FIR filter coefficient values from the coefficient memory and to combine the sample data and the FIR filter coefficient values provided thereto to provide a product signal;
an accumulator configured to receive the product signal from the multiplier circuit at an input thereof and to provide a FIR filter stage output signal corresponding to at least one of n stages of the n-stage FIR filter at an output thereof; and
a feedback signal path coupled between the output of the accumulator and the input of the sample memory and configured to provide the feedback data.

25. The receiver of claim 24 wherein the sample memory comprises an odd sample memory portion and even sample memory portion.

26. The receiver of claim 24 wherein the receiver is configured to send a feedback data along the feedback path, the feedback data corresponding to the FIR filter stage output signal from at least one of a first stage of an n-stage FIR filter through an n−1 stage of the n-stage FIR filter.

27. The receiver of claim 24 further comprising a controller coupled to the adder to control the data values provided to the multiplier from the adder, to the coefficient memory to control the coefficient memory values provided to the multiplier from the coefficient memory, and to the sample memory to control the sample data provided to the adder.
